(19) United States
(12) Patent Application Publication
(10) Pub. No.: US 2009/0309883 A1
(43) Pub. Date: Dec. 17, 2009

(54) COMPUTER SYSTEM AND TOOL AND METHOD FOR MANAGING SHADER CLOCK

(75) Inventors: Chien-Hua Ting, Taipei (TW); Sheng-Shiuan Fan, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/431,745

(22) Filed: Apr. 28, 2009

(30) Foreign Application Priority Data
Jun. 12, 2008 (TW) 97121985

(51) Int. Cl. G06T 1/00

(52) U.S. Cl. 345/501

(57) ABSTRACT

A management method of shader clock includes providing a management interface under an operation system environment for receiving an input of a user. When a frequency value to be set of a shader clock input by the user is received, the management method of the present invention can obtain a plurality of parameter values according to the input of the user and respectively write the parameter values into corresponding shader clock registers so as to dynamically set the frequency of the shader clock.

### CROSS-REFERENCE TO RELATED APPLICATION

This application claims the priority benefit of Taiwan application serial no. 97121985, filed on Jun. 12, 2008. The entirety of the above-mentioned patent application is hereby incorporated by reference herein and made a part of this specification.

### BACKGROUND OF THE INVENTION

1. Field of the Invention

The present invention generally relates to a management technique of a clock, and more particularly, to a management technique of a shader clock.

2. Description of Related Art

A graphics processing unit (GPU) is considered as the heart of a graphic card, wherein the GPU serves as the one equivalent to a CPU (central processing unit) in a computer. A GPU can perform a transform, clipping and lighting processing (T&L processing) in hardware mode. So called the T&L processing is an important component in a 3-dimension shading processing for calculating the 3-dimension positions of polygons and dynamically manipulating light effects, so that the T&L processing can be also termed as ‘geometry processing’.

In a personal computer (PC) before, the most operations of a T&L processing is performed by the CPU of the PC, which is therefore so called soft T&L processing. However, a CPU undertakes heavy burden, which includes not only some tasks not belonging to 3-dimension graphic processing tasks, such as memory management or input response, but also the above-mentioned T&L processing. Therefore, with the T&L processing task, the real efficiency of a graphic card is significantly reduced, so that sometimes the graphic card has work vacancy to wait for the data of the CPU. In short, once a CPU is used also to perform the T&L processing, the operation speed thereof is far from meeting the requirements of the complicated 3D games nowadays.

As a solution, a current graphic card today is usually equipped with the GPU for sharing the burden of a CPU to perform the T&L processing. The clock used by the GPU includes a operation clock and a shader clock, wherein the frequency value of the shader clock greatly affects the executing efficiency of the GPU. Therefore, how to modify the frequency of a shader clock has become a development task concerned by many relevant manufactures.

The conventional approach of modifying the frequency of a shader clock is mostly to use a double-VGA-supported video basic input output system (double-VGA-supported VBIOS) for selecting different frequency values, which needs to switch different frequencies and restart the computer system with considerable inconvenience. In addition, the above-mentioned conventional approach has limited selectable shader clock frequencies only which are insufficient for a user.

### SUMMARY OF THE INVENTION

Accordingly, the present invention is directed to a tool and a method for managing shader clock, which are able to dynamically modify the frequency of the shader clock in a GPU under an operation system environment.

The present invention is also directed to a computer system, which allows a user to directly modify the frequency of the shader clock in a GPU under an operation system environment.

The present invention provides a management tool of shader clock. The management tool includes an interface unit, an operation unit and a writing unit. The interface unit receives an input frequency value of shader clock and the operation unit calculates a plurality of parameter values according to the input frequency value of shader clock. The parameter values are respectively written by the writing unit into a plurality of shader clock registers in the GPU so as to dynamically modify the frequency of the shader clock.

The present invention also provides a computer system, which includes a GPU and a management tool. The GPU has a plurality of shader clock registers for determining the frequency of a shader clock in the graphics processing unit. The management tool is able to modify the value of frequency of shader clock. When the management tool is started, the management tool obtains a plurality of parameter values according to an input frequency value of shader clock input by a user, and the parameter values are respectively written into the shader clock registers in the GPU for setting the frequency of the shader clock.

The present invention further provides a management method of shader clock. The management method includes providing a management interface under an operation system environment for receiving an input of a user. When the user inputs a frequency value to be set of shader clock, the management method of the present invention can obtain a plurality of parameter values according to the input of the user, and the parameter values can be respectively written into the corresponding shader clock registers for dynamically setting the frequency of the shader clock.

Since the present invention takes advantage of writing values into the shader clock registers for adjusting the frequency of a shader clock, so that the present invention is able to dynamically set the frequency of the shader clock without restarting the computer system. In addition, the present invention generates the parameter values according to the input of a user; therefore, the present invention allows the user to freely set the frequency of shader clock as the user's desire.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a computer system according to an embodiment of the present invention.

FIG. 2 is a block diagram of a management tool of shader clock according to an embodiment of the present invention.

FIG. 3 is a flowchart showing the steps for obtaining the parameter values according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

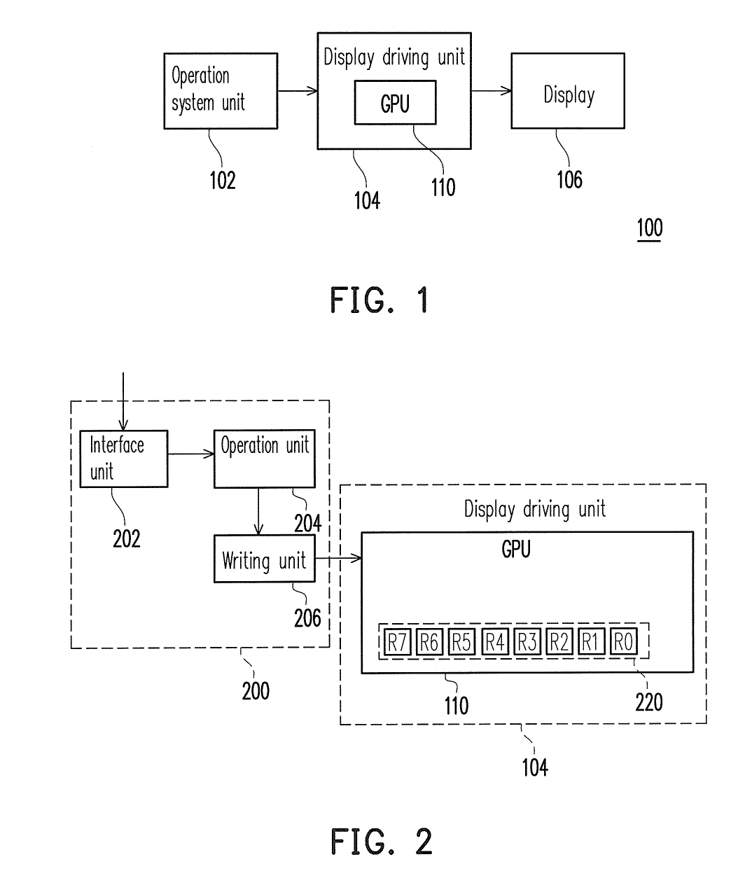

FIG. 1 is a block diagram of a computer system according to an embodiment of the present invention. Referring to FIG. 1, a computer system 100 provided by the embodiment includes an operation system unit (OS unit) 102, a display driving unit 104 and a display 106. The OS unit 102 has an operation system (OS), wherein, after the computer system 100 is started, the OS in the OS unit 102 is loaded so that the computer system 100 is able to provide an operation system environment preset by a user.

The OS unit 102 is coupled to the display driving unit 104. In the embodiment, the display driving unit 104 can be a graphic card, for example, a video graphics array (VGA) graphic card. The most important part of the display driving unit 104 is a GPU 110, which is able to perform a T&L processing from the display driving unit 104 to speed the operation of 3-dimension graphics. The display driving unit 104 is used to drive the display 106. When the display driving unit 104 completes the graphic operation of the image to be displayed for the user, the image is sent to the display 106 for the user to watch, wherein the display 106 can be a liquid crystal display (LCD) or a cathode ray tube display (CRT display).

In general, the GPU 110 works according to a plurality of clock signals, for example, an operation clock signal and a shader clock signal, wherein the most significant signal to affect the efficiency of the GPU 110 is the shader clock signal. So called shader clock signal is just the clock signal required for the GPU 110 to perform shading processing. During the GPU 110 is performing the shading processing, a great deal of data amount is produced; therefore, the frequency of shader clock significantly affects the efficiency for the GPU 110 to perform the shading processing. Based on the above-mentioned consideration, the present invention provides a management tool of shader clock in the OS unit 102 for managing the shader clock in the display driving unit 104.

FIG. 2 is a block diagram of a management tool of shader clock according to an embodiment of the present invention. Referring to FIG. 2, a management tool 200 provided by the embodiment includes an interface unit 202, an operation unit 204 and a writing unit 206. The management tool 200 is coupled to the display driving unit 104. The interface unit 202 is able to display a management interface on, for example, the display 106 as shown in FIG. 1. By means of the management interface, a user can input a value of frequency of shader clock so as to dynamically modify the frequency of shader clock under an operation system environment.

When the interface unit 202 receives the input signal of the user, the input signal is sent to the operation unit 204 for operations to obtain a plurality of parameter values. In some embodiments, the operation unit 204 can obtain the parameter values by searching a Look-Up-Table (LUT) or by calculating according to a formula (more details are depicted later). The parameter values are sent by the operation unit 204 to the writing unit 206. When the writing unit 206 receives the parameter values, the parameter values are written into the GPU 110 in the display driving unit 104.

In the GPU 110, a set of shader clock registers 220 is employed, which has a plurality of shader clock registers, for example, R0, R1, R2, R3, R4, R5, R6 and R7. The shader clock register R0 herein can be the one for least-significant-bit (LSB) and the shader clock register R7 can be the one for most-significant-bit (MSB). In some embodiments, the values registered in the shader clock registers R0, R1, R2, R3, R4, R5, R6 and R7 determine the frequency of shader clock; once the operation unit 204 obtains the parameter values corresponding to the value of frequency of shader clock input by the user, the frequency of shader clock can be dynamically adjusted. In the following embodiment of the present invention, a working flow to obtain the parameter values is described; however, anyone skilled in the art should understand that the present invention is not limited to the following working flow.

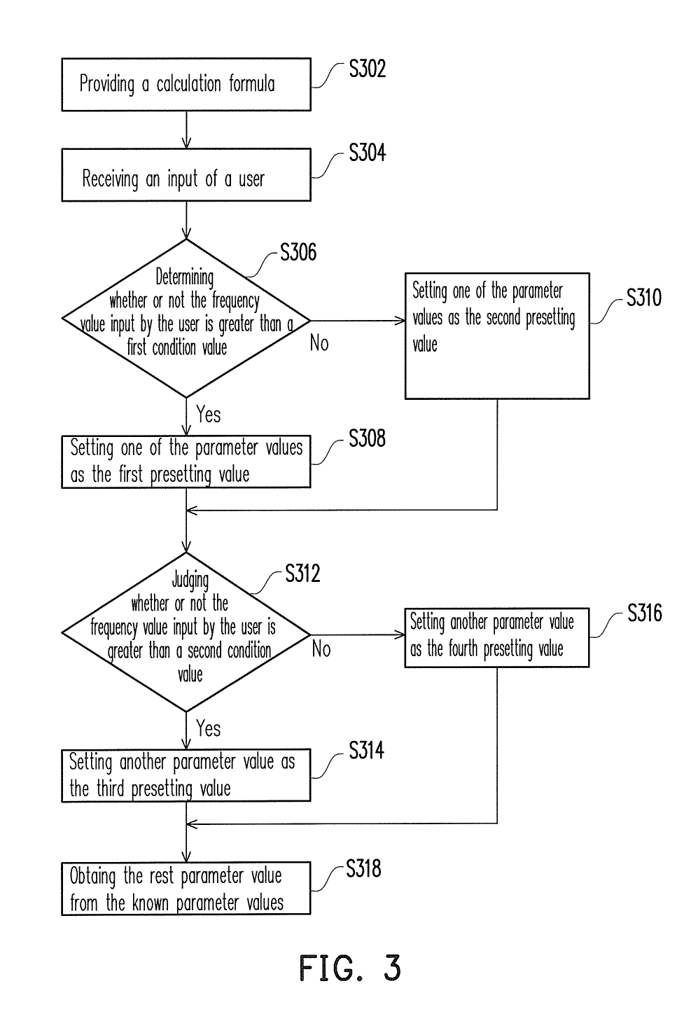

FIG. 3 is a flowchart showing the steps for obtaining the parameter values according to an embodiment of the present invention. Referring to FIGS. 2 and 3, in step S302, the operation unit 204 in the embodiment provides a calculation formula, for example, as follows:

$$Clk = baseband value \times \frac{N}{M} \times \frac{1}{{2}^{P}} \qquad ( 1 )$$

wherein Clk represents a value of frequency of shader clock, and N, M and P can be integers to be written into the shader clock registers R0, R1, R2, R3, R4, R5, R6 and R7 in the GPU 110. In some embodiments, the parameter value N can be greater than the parameter value M. Besides, the baseband value in formula (1) can be 27 MHz.

Next in step S304, the operation unit 204 receives the input of the user from the interface unit 202. Next in step S306, the operation unit 204 determines whether or not the frequency value input by the user is greater than a first condition value; for example, whether or not the frequency value input by the user is greater than 800 MHz. If the frequency value input by the user is greater than the first condition value (correspondingly to ‘yes’ of step S306 in FIG. 3), the working flow goes to step S308 where the operation unit 204 sets the parameter value M as a first presetting value, for example, ‘3’. On contrary, when the value input by the user is less than or equal to the first condition value (correspondingly to ‘no’ of step S306 in FIG. 3), the working flow goes to step S310 where the operation unit 204 sets the parameter value M as a second presetting value, for example, ‘2’.

To obtain all the unknown parameter values A, N and P from formula (I), in addition to assigning the parameter value M, another parameter value must be assigned. That is, after the operation unit 204 conducts step S308 or step S310, the working flow goes to step S312 where whether or not the frequency value input by the user is greater than a second condition value. Similarly, if the frequency value input by the user is greater than the second condition value (correspondingly to ‘yes’ of step S312 in FIG. 3), the working flow goes to step S314 where the operation unit 204 sets another parameter value P as a third presetting value. When the value input by the user is less than or equal to the second condition value (correspondingly to ‘no’ of step S312 in FIG. 3), the working flow goes to step S316 where the operation unit 204 sets the parameter value P as a fourth presetting value. After completing step S314 or step S316, the operation unit 204 obtains the rest parameter value, for example the parameter value N, according to the assigned parameter values and formula (I), as shown by step S318.

Once the operation unit 204 obtains all the parameter values, the values are written by the writing unit 206 into a plurality of corresponding shader clock registers. In some embodiments, the parameter value M is written into the registers R0 and R1, the parameter value N is written into the registers R2 and R3 and the parameter value P is written into the register R4. In this way, the management tool provided by the present invention effectively manages the frequency of the shader clock in the display driving unit 104.

In summary, the embodiment of the present invention is able to obtain the values assigned into the shader clock registers according to the input of the user and is able to adjust the frequency of shader clock by modifying the assigned values in the shader clock registers. Therefore, the present invention allows the user to dynamically adjust the frequency of the shader clock under a preset operation system environment without restarting the computer system, which largely increases the operation convenience of the user.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A management tool of shader clock, capable of dynamically modifying the shader clock of a graphics processing unit as an operational system performing, the management tool comprising:
an interface unit, receiving an input frequency value of shader clock;
an operation unit, coupled to the interface unit for calculating a plurality of parameter values according to the input frequency value of shader clock; and
a writing unit, coupled to the operation unit for respectively writing the parameter values into a plurality of shader clock registers in the graphics processing unit so as to dynamically modify the frequency of shader clock.

2. The management tool according to claim 1, wherein the interface unit provides a management interface for receiving the input frequency value to be modified of shader clock.

3. The management tool according to claim 1, wherein the operation unit calculates the parameter values according to a calculation formula or obtains the parameter values according to a Look-Up-Table.

4. A computer system, comprising:
a display driving unit, having a graphics processing unit, wherein the graphics processing unit has a plurality of shader clock registers for determining the frequency of a shader clock in the display driving unit; and
a management tool, coupled to the display driving unit, obtaining a plurality of parameter values according to an input frequency value of shader clock when the management tool is started, and the parameter values are respectively written into the shader clock registers for setting the frequency of the shader clock.

5. The computer system according to claim 4, wherein the management tool provides a management interface for receiving the input frequency value of shader clock.

6. The computer system according to claim 4, wherein the management tool obtains the parameter values according to a calculation formula or according to a Look-Up-Table.

7. The computer system according to claim 4, further comprising a display driven by the display driving unit.

8. A management method of shader clock, suitable for a graphics processing unit and having a plurality of shader clock registers; the management method comprising:
providing a management interface under an operation system environment for receiving an input frequency value of shader clock;
obtaining a plurality of parameter values according to the input frequency value of shader clock; and
respectively writing the parameter values into the corresponding shader clock registers for dynamically setting the frequency of the shader clock of the graphics processing unit.

9. The management method of shader clock according to claim 8, wherein the parameter values comprise P, N and M, wherein P, N and M are integers and have the following relationship:
value of frequency of shader clock=baseband value×(N/M)×(½^{P})

10. The management method of shader clock according to claim 9, wherein N is greater than M.

11. The management method of shader clock according to claim 9, further comprising following steps:
determining whether or not the input frequency value is greater than a first condition value; and
when the input frequency value is greater than the first condition value, setting the parameter M as a first presetting value; when the input frequency value is not greater than the first condition value, setting the parameter M as a second presetting value.

12. The management method of shader clock according to claim 9, further comprising following steps:
determining whether or not the input frequency value of shader clock is greater than a second condition value; and
when the input frequency value is greater than the second condition value, setting the parameter P as a third presetting value; when the input frequency value is not greater than the second condition value, setting the parameter P as a fourth presetting value.
